(19) United States
(12) Patent Application Publication
(10) Pub. No.: US 2008/0036228 A1
(43) Pub. Date: Feb. 14, 2008

(54) Spreader

(76) Inventors: Herbert Engeler, Baddeckensted (DE); Jorg Steinmetz, Liebenburg (DE)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 10/596,251

(22) PCT Filed: Dec. 3, 2004
(86) PCT No.: PCT/DE04/02683

§ 371 Date: Apr. 24, 2007

(30) Foreign Application Priority Data
Dec. 8, 2003 (DE) 103 57 733.5

(51) Int. Cl. B66C 1/10

(52) U.S. Cl. 294/81.51

(57) ABSTRACT

Disclosed is a spreader for gripping a standard container in connection with a crane mechanism to which the spreader can be hooked via n chain-type suspension gear. Said spreader comprises holding elements (25) that engage into receiving devices of the standard container and are locked with the and of a horizontal control rod especially during transport, by the fact that a switching segment (27) is joined to the control rod assembly (32). Said switching segment (27) is provided with a curved recess (28) for adjusting two switching positions. The switching segment (27) can be raised into a vertical position in an operating position while being retractable into a horizontal position in a transport position.

The invention relates to a spreader for gripping a standard container in conjunction with a crane device to which the spreader can be attached via a chain-type suspension gear, with holding elements which can engage in receptacles of the standard container and can be locked by means of a control linkage running horizontally.

Numerous embodiments of spreaders of this type are known. Since standard containers are gripped and raised with them, spreaders of this type can be constructed with a fixed span matched to the length of the standard container. It is furthermore known to position spreaders in such a manner that two standard containers (placed one behind the other in the longitudinal direction) can be gripped at the same time by them.

It is furthermore known to design spreaders of this type with a telescopic linkage in order to be able to undertake adaptations to length tolerances.

The gripping of the containers usually takes place with holding elements which are designed as twistlock bolts and protrude downward from the spreader. They engage in upwardly open recesses of the standard container and can be locked in the engaged state by rotation through 90° about their longitudinal axes, as a result of which projections of the twistlock bolt engage behind an insertion opening in the recess of the container.

The locking of the holding elements is controlled via a control chain of a chain-type suspension gear with which the spreader is connected to a crane. To form the connection of the control chain to the control linkage, a not inconsiderable amount of space is required which is available without any problems in the case of spreaders which are used in stationary crane systems.

Spreaders which are used in conjunction with mobile crane systems, for example truck-mounted cranes, have also been constructed in a corresponding manner. In this case, it is customary to transport the spreader separately with a corresponding transportation vehicle to the next location of use and to construct the corresponding crane there and to connect the spreader to the crane. In addition to the crane and the spreader, accessories for the use of the crane, for example additional ballast weights, replacement parts and tools, furthermore have to be brought individually or packaged in small bundles to the new location of use. A not inconsiderable outlay on transportation is therefore produced.

The present invention is based on the object of designing a spreader in such a manner that it can be constructed with little space being required and can be transported in an advantageous manner.

According to the invention, to achieve this object, a spreader of the type mentioned at the beginning is characterized in that a switching segment is connected to the control linkage, which switching segment has a curved recess for setting two switching positions and which, in an operating position, can be raised into a vertical position and, in a transportation position, can be folded down into a horizontal position.

The spreader according to the invention therefore has a switching segment which is suitable for controlling the switching linkage for the holding elements and is therefore connected to this switching linkage. However, the connection takes place via a rotary joint which preferably lies transversely with respect to the switching linkage and permits the switching segment to be folded down from an upright operating position into a horizontal transportation position. In this folded-down, horizontal transportation position, because of the switching segment the spreader obviously does not require any additional construction height going substantially beyond the height of the spreader frame.

The transportation of the spreader according to the invention preferably takes place with a transportation container on which the spreader is placed and is connected by its holding elements in locked form. In this case, it is expedient if the transportation container has the same area as a standard container.

A spreader is usually provided with flat side guides with which the spreader is brought to bear against at least one longitudinal side and one transverse side of the container to be raised, in order thus to center the spreader relative to the container. Accordingly, in an operating position, these side guides have to protrude over the area of a standard container. In a preferred embodiment of the invention, in an operating position, side guides are connected to the spreader via spacer elements connected inbetween in such a manner that said side guides protrude laterally over the area of a standard container, and, in a transportation position without spacer elements, are displaced toward the spreader in such a manner that they are arranged within the area of a standard container. Additionally, in the operating position, the side guides can be arranged protruding downward and, in the transportation position, can be rotatable through 90° into a horizontal position.

A preferred field of use of the spreader according to the invention lies in its capability of being used to form a transportation unit with a special transportation container in such a manner that the transportation unit can be transported as a standard container. Accessories required below the spreader, in particular for the crane, can be transported in the container, with the result that separate transportation of the spreader is not required.

The invention is described in more detail below with reference to an exemplary embodiment and the attached drawings. In the drawings

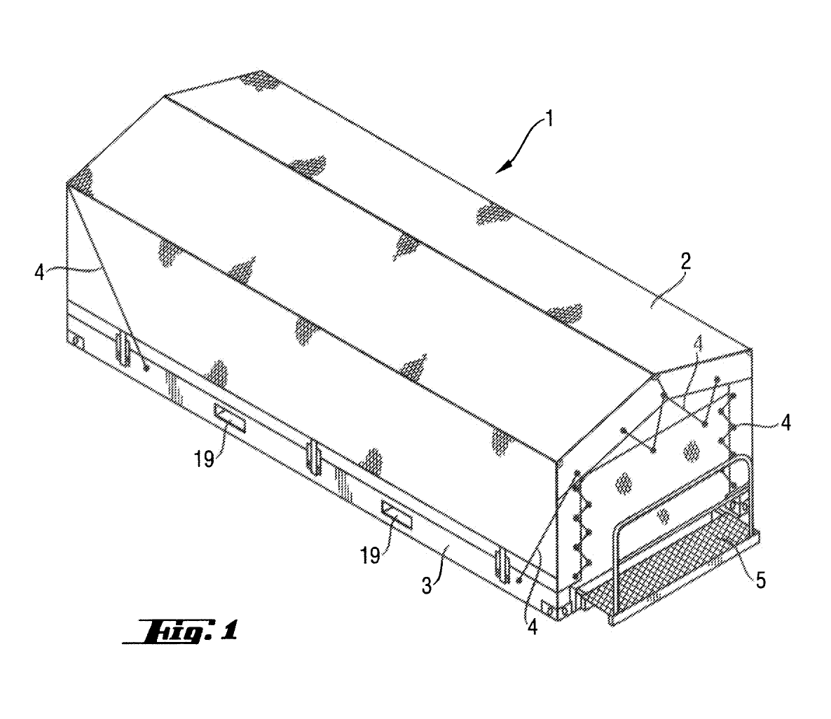

FIG. 1-shows a perspective illustration of the transportation unit which is closed by a tarpaulin;

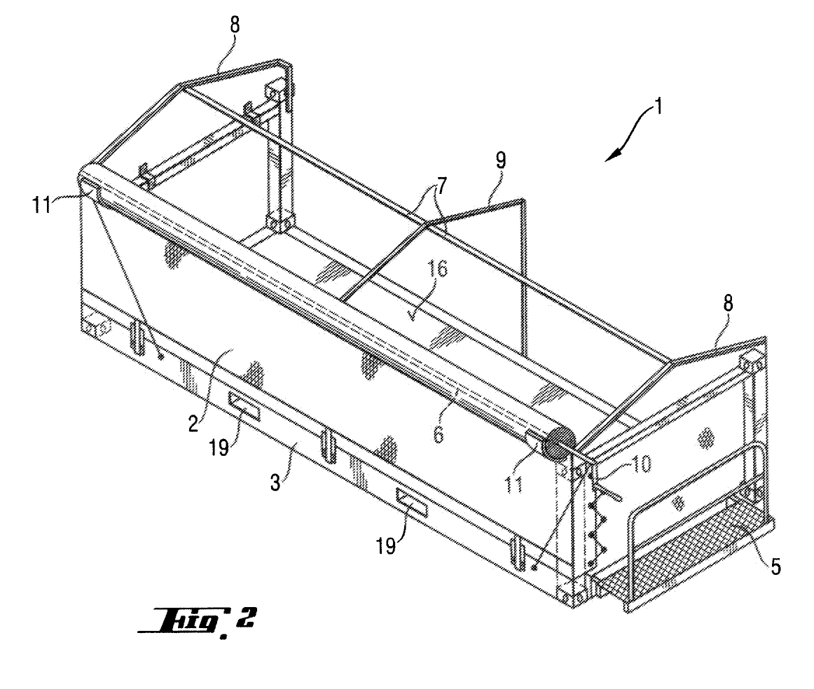

FIG. 2-shows a perspective illustration of the transportation unit from FIG. 1, with the tarpaulin rolled up to one side;

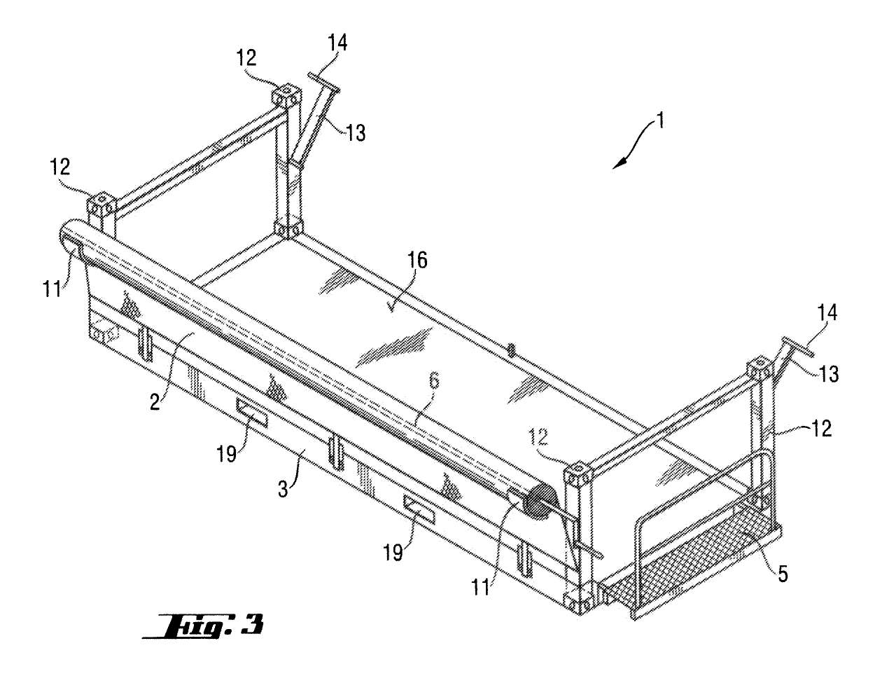

FIG. 3-shows a perspective illustration of the container from FIGS. 1, 2, in which the rolled-up tarpaulin is shown pivoted out of the contour of the container;

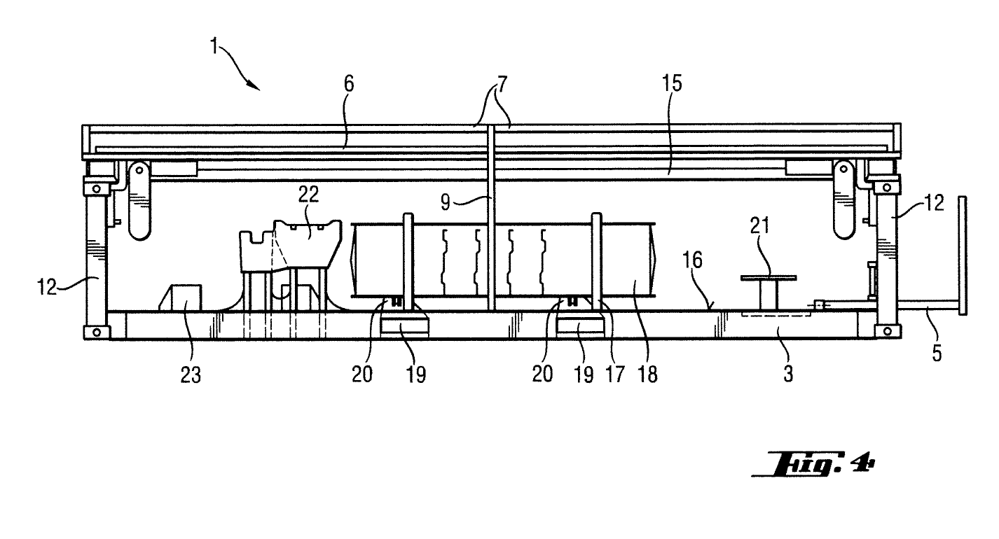

FIG. 4-shows a side view of the transportation unit;

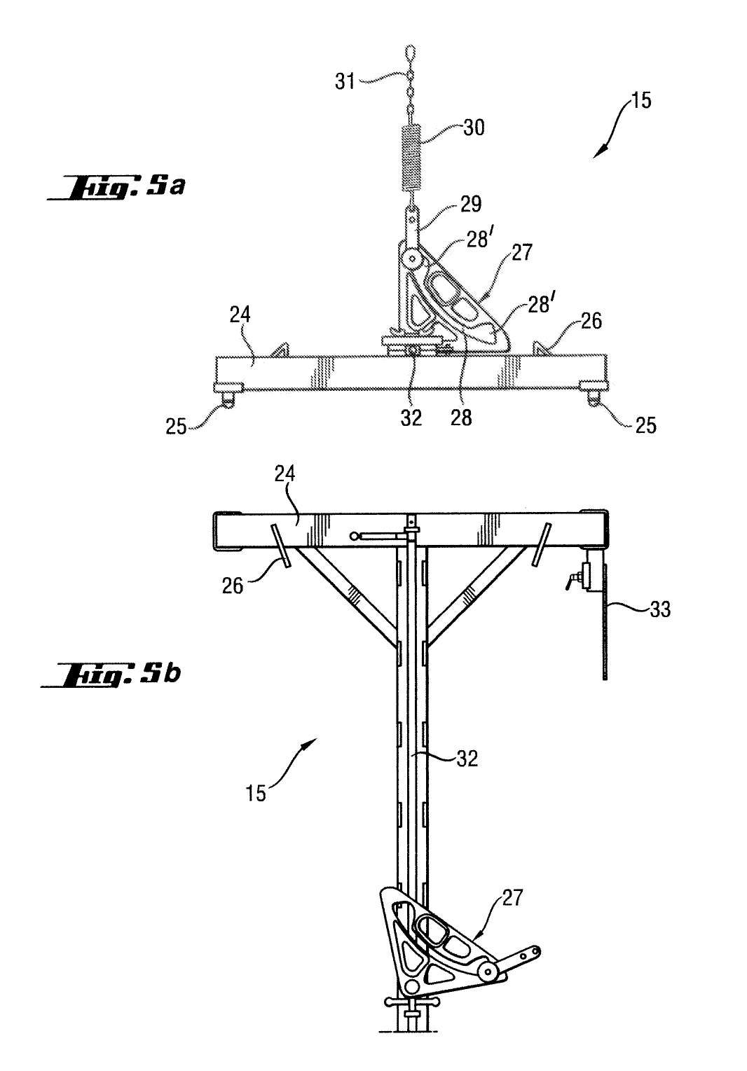

FIG. 5a-shows a front view of the spreader with a switching segment in the operating position;

FIG. 5b-shows a plan view of the spreader with the switching segment in the transportation position;

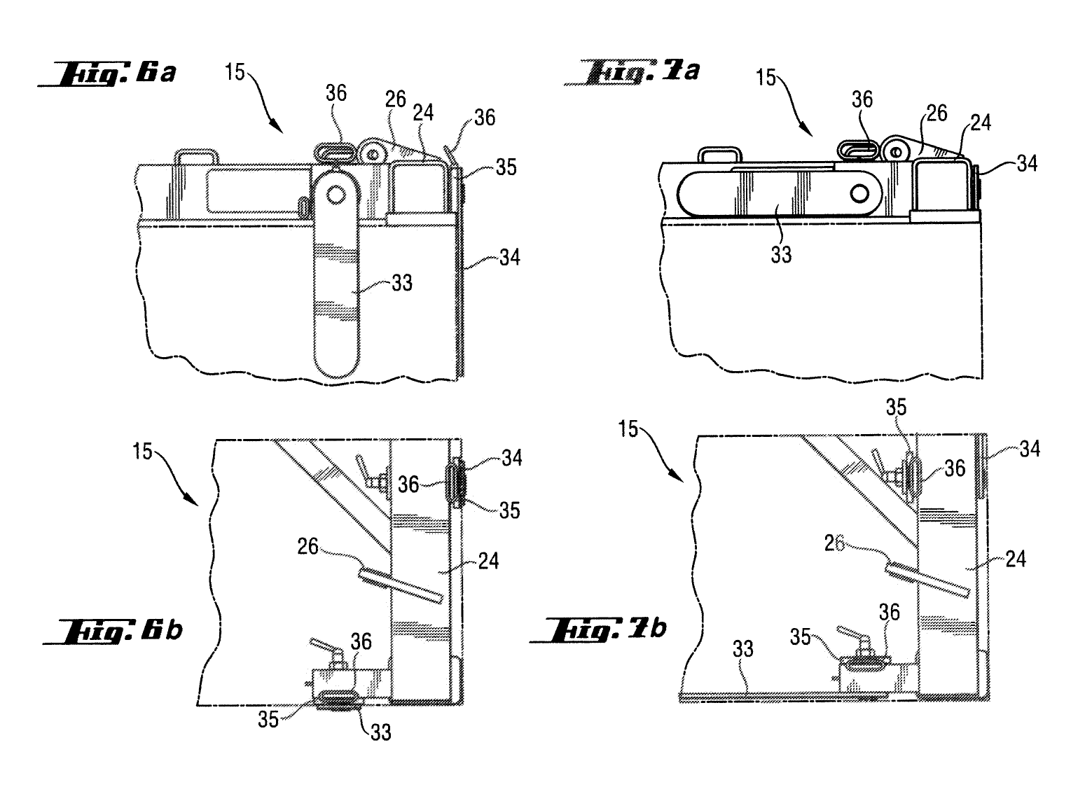

FIGS. 6a, b-show partial views of the spreader with side guides in the operating position, in a side view and in a plan view, respectively;

FIGS. 7a, b-show partial views of the spreader from FIG. 6 with the side guides in the transportation position, in a side view and in a plan view, respectively.

FIG. 1 illustrates a transportation unit 1 according to the invention in a perspective view. The transportation unit 1 is covered by a tarpaulin 2, so that only the lower region of the container 3 can be seen. The tarpaulin 2 is fastened to the container 3 by elastic tension ties 4. The tension ties 4, which are under tension, adequately fix and secure the tarpaulin 2 even during transportation by a truck and the relative wind occurring in this case. Although not illustrated in this figure, it may be expedient also to connect the tarpaulin 2 to the container 3 on the longitudinal side of the container by means of tension ties.

Working platforms 5 which can be pulled out can be integrated on the end sides of the container. If the transportation unit is transported on a conventional truck, it is expedient to provide a working platform 5 of this type at least on the rear end side. After the working platform 5 has been pulled out, an operator standing on it can release the tension ties 4 and roll up the tarpaulin 2.

FIG. 2 illustrates the transportation unit 1 in the same perspective as in FIG. 1. However, in FIG. 2, the tarpaulin 2 is rolled up from the longitudinal side, which is situated at the rear in the plane of projection, of the container 3 toward the side facing the observer. In the exemplary embodiment presented here, the lateral longitudinal rods 6 arranged on the upper longitudinal edges of the container are connected to the tarpaulin 2 and are rolled up together with it. A central longitudinal rod 7 is connected to gable rods 8 arranged on the end sides. An additional central gable 9 is situated approximately in the center of the length of the container.

The tarpaulin 2 may be folded away either to the right or to the left side of the container 3. For this purpose, first of all the tension ties 4 on the side to be opened and on the gable region are released. Those subregions of the tarpaulin 2 which hang on the end sides are then folded up onto the top side. Subsequently, a hand crank 10 is inserted into the lateral longitudinal rod 6 on the side which is to be opened. The hand crank 10 can be fastened to the transportation unit 1 in the interior during transportation. Simpler handling can be ensured if a respective hand crank 10 is inserted at both ends of the lateral longitudinal rod 6 and two people operate the hand cranks in order to avoid skewing. The lateral longitudinal rod 6 is now rotated in the direction of the central longitudinal rod 7 by means of the hand cranks 10 and, in the process, the tarpaulin 2 is rolled up on the longitudinal rod 6. The side wall of the tarpaulin 2 and the roof are wound up at the same time. This enables the tarpaulin 2 to be rolled up as far as the other side and, in the process, opens up one side and the top side of the transportation unit 1. Subsequently, supporting shells are removed from a transportation position, which can be provided, for example, on the cross members of a spreader, and are inserted into the tarpaulin-frame side tube (not illustrated). The rolled-up tarpaulin 2 is placed onto the supporting shells.

FIG. 3 illustrates the container 3 in a fully opened-up state. In comparison to the situation illustrated in FIG. 2, the central longitudinal rod 7, the gable rods 8 and the central gable 9 (all from FIG. 2) have now been removed. Simpler operation is achieved if the central longitudinal rod 7 is composed of two partial rods. Pivoting-away levers 13 are situated at the four corner posts 12 of the container 3. The side tubes 14 into which the supporting shells 11 are inserted are arranged at the free end of the pivoting-away levers 13. It should be noted that, in the illustration shown, the pivoting-away levers 13 and side tubes 14 are not shown on the side of the container at which the tarpaulin roll 2 is situated. However, they can clearly be gathered from the figure on the fully opened side of the container 3.

After the tarpaulin 2 has been rolled up completely to one side, and the gables 8, 9 and the central longitudinal rod 7 have been removed, the tarpaulin 2 can be pivoted out of the contour of the container by the pivoting-away levers 13. For this purpose, first of all the tension ties, which are still fastened to the end sides, are to be released and the pivoting-away levers 13 are to be unlocked. After the tarpaulin 2 has been pivoted out, the container 3 is completely opened up.

FIG. 4 shows a side view of a transportation unit 1 according to the invention in a state provided for transportation, but, for the sake of clarity, the tarpaulin is omitted and is not shown. The illustration shows the container 3 with the spreader 15 situated on it. The working platform 5 has been pulled out in the drawing. Furthermore, a tarpaulin frame, comprising the longitudinal rod 6 and the central longitudinal rod 7, is arranged on the container 3. To support the longitudinal rods, the central gable 9 is fastened approximately in the center of the length of the container 3.

The spreader 15 rests on the container 3 or on the four corner posts 12 of the container 3. In this case, holding elements (not illustrated) of the spreader 15, for example twistlock bolts, can engage in corresponding receptacles in the corner posts 12. The effect achieved by this is that, firstly, the spreader 15 is connected fixedly to the container 3 for transportation and, secondly, the twistlock bolts are thus protected against damage during transportation.

Fastening devices 17 for the fastening of additional ballast weights 18 for a mobile crane are provided on the container 3. The additional ballast weights 18 are arranged approximately in the center of the container 3 in order to obtain an approximately balanced distribution of weight even when a container is fully loaded. Forklift truck pockets 19 are situated below the ballast weights, so that a forklift truck can also unload the container from a transportation truck. The construction of the forklift truck pockets 19 is designed in such a manner that it serves at the same time as a supporting element of the supporting bearings 20 for the ballast weight 18. The forklift truck pockets 19 have an approximately U-shaped cross section. Furthermore, the central region is lifted into a plane above a container base 16 and serves as a support for the ballast weights 18. The self-supporting construction makes the container easier to produce.

In this illustration, further crane components can be fastened to the container laterally next to the ballast weight 18. Thus, a fastening device 21 for a spare wheel (not illustrated) is provided. Fastening devices (22) for snatch blocks (not illustrated) are situated on the other side of the ballast weights 18. In addition, boxes 23, for example for chain-type suspension gear, replacement parts or tooling, can be provided. The container 3 is designed with a stable base 16 which can be walked on. The further various fastening devices can be arranged on the base 16 in order to fix the additional components for the crane system.

However, care should be taken with the additional crane components to ensure that the transportation unit with the complete load does not exceed the permissible overall weight for a container, so that it can be transported on a conventional truck or an off-road transportation vehicle. Furthermore, it is expedient to align the component arrangement within the container 3 in such a manner that the permissible ranges for axle loads during transportation by a truck are kept to.

FIG. 5a illustrates a front view of the spreader 15. A crossmember 24, at the outer ends of which twistlock bolts 25 are arranged on the lower side, can clearly be seen. Fastening eyes 26 to which a chain-type suspension gear (not illustrated) can be fastened by means of shackles can likewise be seen. Situated in the center of the spreader 15 is an approximately triangular switching segment 27 with a curved recess 28 which is approximately in the form of a quarter circle and is provided at the ends with essentially upwardly directed locking pockets 28′.

The switching fork 29 is connected to the chain-type suspension gear via a tension spring 30 and a switching chain 31.

The switching segment 27 stands upright on the spreader 15. To lock and unlock the twistlock bolts 25, the switching segment 27 is rotated in each case through approx. 90°. The center of rotation is situated on the triangular point of the switching segment 27 on which the two legs bear. By rotation of the switching segment 27, a switching linkage 32 is driven. The switching movement is triggered by the chain-type suspension gear. By means of the switching chain 31, which is secured by means of the tension spring 30, the switching segment 27 is pivoted in each case to and fro through 90°. By letting down the switching fork 29, the latter migrates downwards through the curved recess into the region of the lower locking pocket 28′, which is illustrated in FIG. 5a. By raising the switching fork again, there is pivoting at the center of rotation through 90° about an axis of rotation directed parallel to the switching linkage 32. The switching element is then pivoted back in an analogous manner in an approximately mirror-symmetrical position. The locked position can be indicated on the switching segment by a particular color, for example red.

In FIG. 5b, the spreader 15 is illustrated in the transportation position in a plan view. It is essential that the switching segment 27 is folded down in the longitudinal direction and therefore rests on the switching linkage 32. The tension spring 30 and the switching chain 31 have already been removed for transportation purposes. Furthermore, in this illustration, a side guide 33 can be seen which is described in more detail below with reference to FIGS. 6 and 7.

FIGS. 6 and 7 show partial views of the spreader 15 from FIG. 5 with two side guides 33 and 34 in each case. In this case, FIGS. 6a and 7a are side views and FIGS. 6b and 7b are plan views.

FIG. 6 shows the side guides 33 and 34 in the working position, i.e. they are aligned at an angle of approximately 90° to the spreader 15 and point downward. As can be gathered from FIG. 6a, the side guide 34 is situated outside the contour of a standard ISO container. Spaces 35 with a holding handle 36 are inserted between the spreader 15 and the side guides 33 and 34.

In FIGS. 7a and 7b, the side guides 33 and 34 are in the transportation position, i.e. they are rotated through 90° and are situated in the plane of the spreader 15. The spacers 35 have now been inserted on the inside of the spreader 15, as a result of which the side guides 33 and 34 are displaced toward the spreader 15, so that they lie within the contour of a standard ISO container.

Although, in the exemplary embodiment, the spreader 15 is illustrated in an embodiment as a fixed spreader, it is likewise possible to use a telescopic spreader. Furthermore, hook-in elements can be welded to the spreader 15 at all four corners. Guide cables may optionally be hooked into these hook-in elements in order manually to guide the spreader hanging in the chain hook. The guide cables can be stored during transportation in a chain box of the container 3. Operating levers or double levers for the manual actuation of the twistlock bolts can be provided on the two end sides of the spreader 15 or at the ends of the longitudinal switching shaft of the switching linkage 32. In each case two guide cables, with which the 90° switching movement can be carried out manually, can be hooked into one of the switching levers.

1. A spreader for gripping a standard container in conjunction with a crane device to which the spreader can be attached via a chain-type suspension gear, with holding elements (25) which can engage in receptacles of the standard container and can be locked by means of a control linkage (32) running horizontally, characterized in that a switching segment (27) is connected to the control linkage (32), which switching segment has a curved recess (28) for setting two switching positions and which, in an operating position, can be raised into a vertical position and, in a transportation position, can be folded down into a horizontal position.

2. The spreader as claimed in claim 1, characterized in that the holding elements (25) comprise twistlock bolts.

3. The spreader as claimed in claim 1, characterized in that, in an operating position, side guides (33, 34) are connected to the spreader (15) via spacer elements (35) connected inbetween in such a manner that said side guides protrude laterally over the area of a standard container, and, in a transportation position without spacer elements (35), are displaced toward the spreader (15) in such a manner that they are arranged within the area of a standard container.

4. The spreader as claimed in claim 3, characterized in that, in the operating position, the side guides (33,34) are arranged protruding downward and, in the transportation position, can be rotated about 90° into a horizontal position.
